(19) United States
(12) Patent Application Publication
(10) Pub. No.: US 2007/0118413 A1
(43) Pub. Date: May 24, 2007

(54) Method Of Administration And Health Management

(76) Inventor: Jonathan R. Javors, Valparaiso, IN (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/627,222

(22) Filed: Jan. 25, 2007

Related U.S. Application Data
(62) Division of application No. 09/833,254, filed on Apr. 11, 2001, now abandoned.
(60) Provisional application No. 60/229,887, filed on Sep. 1, 2000.

(51) Int. Cl. G06Q 40/00

(52) U.S. Cl. 705/4

(57) ABSTRACT

A method for benefits administration is described. A benefit plan is provided, comprised of a Health Care Account and an Umbrella Account. Through financial incentives, benefit plan beneficiaries are encouraged to spend funds in the funded Health Care Account and the funded Umbrella Account so that, at the end of the benefit plan year, unspent funds are distributed back to the beneficiaries. A method of health management is also described, comprising a Health Team to provide health care services and health management to a group of benefit plan beneficiaries. The Health Team is designed to maintain the well being of the group, to maximize efficient spending of health care dollars. A clinical information system is also described, comprising a third party administrator component, a health management component, and a health risk assessment/medical history component.

### CROSS-REFERENCE TO RELATED APPLICATIONS

This application is a Divisional Application of U.S. patent application Ser. No. 09/833,254, filed Apr. 11, 2001, entitled METHOD OF ADMINISTRATION AND HEALTH MANAGEMENT, which claims priority of U.S. Provisional Application Ser. No. 60/229,887, filed Sep. 1, 2000. All of the above-referenced patent applications are incorporated herein by reference.

### BACKGROUND OF THE INVENTION

In recent years, the health insurance industry has been dominated by managed care companies, which focused on reducing the cost of medical care primarily through restrictive measures. Initially, employers were willing to accept their restrictions in return for reduced premium costs each year.

However, according to the 1999 Towers Perrin Health Care Cost Survey, it was predicted that in 1999 employers would begin to see the highest increases in health care premium since 1993; finding an overall increase of 7% for active employees and as high as 10% for retirees. In addition, extensive patient and provider discontent due to managed care organizations' efforts to limit access to care and lack of concern on the quality of care has resulted in a backlash against these organizations.

The current American system of health care has been shaped by critical developments that occurred over thirty years ago:

1. the introduction and spread of the third party hospitalization insurance payer in the 1930s;

2. the broad provision of health care benefits by employers in the 1940s; and

3. the establishment of Medicare and Medicaid in 1965.

These events resulted in a fracturing of the traditional role of a customer of medical services into three distinct activities that are engaged by separate participants in the system, often with competing economic objectives: the decision-maker (physician), the payer of the services (employer or government), and the consumer (patient). This separation of customer roles led to the rapid, unchecked growth of health care expenditures followed by the adoption of a variety of control mechanisms to limit costs by “managing” medical care. The result has been turmoil, uncertainty, and dissatisfaction by all involved—physicians, hospitals, insurance companies, politicians, employers, and most importantly, patients. Accordingly, a different approach is required to find a solution to these problems.

After a decade of experimentation and evaluation, it has become apparent that the managed health care model is inadequate to form an equitable, cost-effective health care system. Managed care is ineffective because it attempts to control costs primarily by impacting the supply-sided demand (physician controlled) of health care delivery. The mechanisms used by the managed care model to control costs have taken the form of capitation, negotiated rates of service and, in the most stringent form, penalties for both patients and physicians if the rules are not followed. Little wonder there is a growing patient and provider backlash against managed care.

A significant flaw in managed health care is that it treats the employer or government as the most important component in health care. However, a customer, combining the roles of decision maker, payer and consumer, is always the most important part of any successful business. Health care is no different. In health care the patient, the consumer of the service, is the most logical locus to recreate the classic customer that integrates the roles of decision maker, payer and consumer. The patient becomes the customer.

Interactive Health Care will shift the paradigm in health care. This shift is accomplished by introducing three value-added components currently lacking. The first is the implementation of patient economic incentives to curtail ineffective and unnecessary treatment by incorporating the payer role of the customer. The second is the movement of the system from the treatment of diseases to a focus on comprehensive prevention, early detection and disease management. The third is the addition of personalized health service teams to assist patients in all aspects of their health. Together, these generate interactive patient care by returning to the consumer (patient) the responsibility for making informed decisions, allowing them to retain greater control of the purse strings at the point of service, thereby increasing their stake by the decisions that they make.

Health Care Delivery Today

In today's model of health care delivery, the insurance company and managed care organization (MCO), play a strong, controlling role. Managed Care Organization, or MCO, is the generic term for managed care companies including health maintenance organizations (HMOs), preferred provider organizations (PPOs), and independent provider organizations (IPOs). These organizations dictate what services will be covered and at what cost. Historically, patients with full coverage insurance were often encouraged by providers to over-utilize healthcare services because there were no direct costs to the patient for the services, and providers often had a financial incentive to promote over-utilization of these services.

MCOs have addressed over-utilization to some degree through attempts to limit medical procedures and aggressively negotiated payment rates with providers. MCOs did help employers to better control annual premium increases during much of the 1990s. However, this trend is currently reversing. Moreover, under this model the patient has virtually no control or incentive to optimize utilization of medical services; in particular, the focus has been on disease treatment as opposed to disease management.

For years, managed care companies had a strong focus on reducing the cost of medical care, mainly through restrictive measures. Employers were willing to accept these restrictions in return for reduced annual premiums. According to a recent study, in 1999 employers were expected to see the highest increases in health care plan costs since 1993; 7% for active employees and as high as 10% for retirees. 1999 Towers Perrin Health Care Cost Survey (“Towers Perrin”).

Employers have taken notice of the sharp increases in costs projected for 1999 and beyond. In addition, extensive employee discontent due to managed care organizations' efforts to limit their access to medical services and a disregard on the quality of care they receive has been well documented.

According to a William M. Mercer study, employers are willing to take action when their employees are dissatisfied. Specifically, the study found that 84% of all employers monitor employee satisfaction with their health insurance and make changes as a result of their findings. Indeed, 28% of the employers dropped one or more HMOs because of this dissatisfaction. (1997 William M. Mercer, Inc. survey of 283 company benefits executives.) The perception of Americans is that managed care will negatively affect their quality of medical care.

The following points outline the current state of managed care trends and the concerns of employers and employees: The focus of managed care has been cost reduction; however employers now face significantly rising premiums

1. Employers are concerned about the quality of care provided to their employees because this has been a secondary focus to cost

2. MCOs are not currently positioned to provide “patient focused” care, and will not be in the future

3. After a number of years of overall slowing in the rate of growth in health care costs, employers are facing significantly rising premiums

4. Patients are not currently actively involved in their own health care. They want to be, but do not have the information to do so

5. Providers often cannot keep up with the continuity of patient care due to the episodic nature of their interaction with patients

6. Patients have only minimal financial incentives to help control their utilization of medical services

The strongest contributor to the high cost of medical insurance is the over-use of medical services. This occurs due to patients' lack of medical information and/or access to information. As an example, it is well documented that, as a whole, physicians utilize medical services less than the general public for comparable illnesses. Moreover, it is a common perception that the physician has the exclusive knowledge to make the right choice when it comes to medical treatment. Research has shown, however that a patient's lack of understanding of “what to do” causes them to not take preventive measures to avoid serious conditions.

Accordingly, the more extreme a patient's health condition, the greater his or her need is for information. The Journal of the American Medical Association reports:

Patients with low health literacy and chronic diseases, such as diabetes, asthma, or hypertension, have less knowledge of their disease and its treatment and fewer correct self-management skills than literate patients. They say these factors may explain why patients with inadequate functional health literacy are more likely to be hospitalized than those with adequate health literacy. February 1999, Journal of the American Medical Association.

According to the researchers, among the implications of the study is that clinicians need to be aware of the prevalence of health literacy problems and need to identify patients with poor health literacy skills, and health care organizations should be aware that inadequate health literacy may adversely affect costs and delivery of care. February 1999, Journal of the American Medical Association.

The financial implications of inadequate patient literacy are significant for patients and their employers. The significance is not diminished by a growing trend of younger and middle-aged persons using the Internet as a source of medical information; rather this demonstrates the demand for information. Therefore, the data describing patient literacy are disturbing, because there continues to be a prevalence of individuals who are not receiving the right information, and are therefore likely to utilize health care services poorly. Inappropriate utilization of medical services results in a higher cost of insurance.

Research has shown that a small segment of the population accounts for a dramatically large portion of overall health care costs. Consider that 20% of a patient population accounts for 80% of the health care costs (HBOC: Data Analysis from Managed Care Organization claims, marketing materials). Moreover, only 6% of the Medicare population incurred 48% of program payments with average charges for this top 6% of over $45,000 per person. 1998 Medicare and Medicaid Statistical Supplement published by Health Care Financing Review, HCFA.

Disease state management (DSM) is a concept that has been used since the early 1980's. DSM defines the best way to treat a given disease based on the latest medical and behavioral research. Essentially, DSM offers patients with certain medical conditions an opportunity to enact preventive, active/acute, and follow-up management of the disease.

There is significant employer interest in DSM programs. A recent study showed that 87% of employers had “strong” or “growing” interest in DSM programs (Towers Perrin) and another study found that 63% of employee benefits managers at major corporations view DSM programs as an important service provided by their HMO or pharmacy benefit manager (PBM) (a company that manages pharmaceutical requirements for MCOs). CibaGeneva Pharmacy Benefit Report: 1996 Trends and Forecasts. However, for all of the interest and efforts, DSM in its current state has failed to deliver strong results in improving health in patients or in lowering insurance costs for employers. Whereas about 20% of U.S. households have access to health and disease management programs offered by their insurer or employer, only 3.8% participate in them. CibaGeneva Pharmacy Benefit Report: 1996 Trends and Forecasts. Clearly, the current system is not focused closely enough on the individual beneficiary. The present invention provides a greater response to this program.

Disease state management has become a well-defined concept over the last five years. The concept represents great potential for improved health for patients and lower health care costs for employers. However, the concept to date has met with limited success, and some may argue, failure. Why? Physicians are inundated with updates on disease state management protocols from hospitals, insurance companies, the AMA, and universities. The problem is that few physicians spend time reviewing these programs, or have the incentive to follow their recommendations. In addition, the patients themselves rarely see these programs at all, and often do not understand the role they can play in managing the disease. The breakdown is not occurring in the information content, but rather the execution of these programs. What one realizes is that once the content is made clear, real change management efforts must be directed at both patients and providers to change accepted ways of doing things and to overcome conflicting incentives.

Where prevention and disease state management programs have been enacted successfully, almost 80% of all beneficiaries utilize this service, and over 90% of those are satisfied with the service. Barnett, Alice Ault, Is Knowledge Really Power For Patients?, Business and Health, Vol. 13, 29-26 (May 1995). As importantly, studies reveal that for every dollar spent on these programs, between $3.17 and $4.75 is saved. Id. at 30-31; Goldstein, Marc Alan, Demand Management Looks Promising, Too, Modem Healthcare, 144, (Aug. 21, 1995).

The challenge is how to get people to use these programs. The present invention provides economic incentives to present one solution to this problem.

### BRIEF SUMMARY OF THE INVENTION

In one aspect, the present invention provides a method for benefits administration for a beneficiary comprising the following steps. A benefit plan for a benefit year comprising a Health Care Account and an Umbrella Account is provided. Premiums are collected for deposit into the benefit plan to form a funded Health Care Account and a funded Umbrella Account. Claims made by a benefit plan beneficiary are processed to form processed claims. Funds are then disbursed from the funded Health Care Account or the funded Umbrella Account to pay the processed claims. Any funds remaining in the funded Health Care Account or funded Umbrella Account is then distributed at the end of the benefit year.

In a preferred embodiment, funds are first disbursed from the funded Health Care Account until it is depleted, and then from the funded Umbrella Account.

Preferably, funds are disbursed to health care service providers to pay a processed claim. Alternatively, funds are disbursed to the benefit plan beneficiary as a reimbursement for monies paid to health care service providers directly from the benefit plan beneficiary.

In another preferred embodiment, the distributing of funds at the end of the benefit year is done directly to the benefit plan enrollee. In an alternative embodiment, the distributing of funds at the end of the benefit year comprises paying any funds remaining in the funded Health Care Account or the funded Umbrella Account directly to a retirement plan for the benefit of the benefit plan enrollee. In another alternative embodiment, the distributing of funds at the end of the benefit year comprises paying any funds remaining in said funded Health Care Account or said funded Umbrella Account directly to an Extended Care Account for the benefit of the benefit plan enrollee.

Preferably, the distribution of any funds remaining in the funded Health Care Account or the funded Umbrella Account is actuarially determined.

In another aspect, the present invention provides a method of health management comprising providing a Health Team for a defined group of benefit plan beneficiaries. The Health Team is responsible for services to the defined group of benefit plan beneficiaries. These services comprise the following. Prevention protocols are provided to the defined group of benefit plan beneficiaries. Health Risk Assessment Data and Medical History is collected for each member of the defined group of benefit plan beneficiaries. Medical and health services claims are paid for specific members of the defined group of benefit plan beneficiaries. Utilization review and pre-certification services are performed for specific members of the defined group of benefit plan beneficiaries. Telephone triage is performed for specific members of the defined group of benefit plan beneficiaries. Health information, including automatic health and early detection reminders, is provided to specific members of said defined group of benefit plan beneficiaries. Disease-specific outcomes are monitored to identify specific at-risk members of the defined group of benefit plan beneficiaries with disease states amenable to pro-active medical and health interventions, and appropriate preventive or therapeutic intervention are secured for the specific at-risk members. Disease and case management services and programs are implemented for the specific at-risk members of the defined group of benefit plan beneficiaries.

In yet another aspect, the present invention provides a clinical information system comprising a third party administrator component, a health management component, and a health risk assessment/medical history component.

Preferably, the third party administrator component of the clinical information system comprises a basic claims administration software system, an ad hoc reporter writer, a code review system, a case management system, and accounting software. More preferably, the third party administrator component further comprises a funds disbursement system.

In a preferred embodiment, the clinical information system further comprises a pharmacy benefits management component.

The present invention provides the following benefits and advantages:

1. economic incentives to patients to become health care customers once again;

2. information and education for patients on medical procedures, outcomes and costs;

3. health screening and preventive care; and active management of chronic and critical cases.

The present invention takes advantage of the opportunity created by the failure of MCOs by reducing the short and long-term premium costs to employers, improving the health and quality of care of employees and their dependents; and increasing the satisfaction of medical providers and patients. It is believed that greater personal involvement of patients in their health issues, and a shift from the current industry practice of onset treatment of disease to the use of clinically proven disease management and prevention programs, will result in better care at a lower cost. The present invention is designed to encourage patients to become more involved in their health care through a system of financial reward, and by both active and passive mediums of communication of relevant information.

### DETAILED DESCRIPTION OF THE INVENTION

The present invention solves many problems by introducing patient economic incentives and interactive health services, combined with personal health support to provide the information that patients need to become discerning health care decision-makers. The invention will function equally well as a fully insured plan, self-insured plan, or in a single pay system. Benefits claims administration is combined with comprehensive health services management in a unique fashion that leads to better health, higher morale, improved productivity, and lower costs.

Economic Incentives

Interactive Care harnesses the induction effect to bring the patient into the health care system as the decision-maker, the payer, and the consumer. In a nutshell, the induction effect which is an actuarial principle, states that a person spend his or her money in a more discerning method than someone else's. Who's Paying the Bill?: Medical Savings Accounts, Costs Implications and Design Issues, American Academy of Actuaries, May 1995. In health care, this translates to lower costs as demand for services is diminished.

In health care today there are two sources of funds, the individual (family) and the payer (employer/government) The induction effect states that the larger the individual's or families' share of the cost, the lower the demand will be for health care services and treatment.

The present invention provides three “spending” accounts, whereas managed care and fee-for-service uses two. Interactive Care takes a portion of the major medical aspect (Umbrella Account) and drops it in between the deductible and major medical, as a Health Care Account (HCA). The HCA functions essentially as a medical expenditure account. After the deductible has been met, the HCA is used for the next line of payment. The induction effect occurs in part because if there is any money remaining in the HCA at the end of the benefit year, it will be distributed in one of at least three ways, depending on plan design. The first is that it can be taken as a taxable cash bonus. The second is that it can be rolled over into the individual's IRA, depending on the employer's retirement plan. In this case it would not be taxable until taken out after retirement. The third is that the money can be placed in a non-taxable, interest bearing Extended Care Account (ECA), that can be used only for medical services, such as home health care, hospice care, or next year's deductible. The ECA is portable to the individual.

There is a second economic incentive in Interactive Care. Actuarially, the amount of medical claims is determined for the covered population, using methods that are well known in the art. If the group as a whole spends less than this actuarially determined amount in the benefit year, then the remaining funds are distributed equally between payer (e.g. employer) and the covered population, with a pre-determined amount spent on prevention for the group the following year.

This acts to increase the induction effect. While the HCA is an individual incentive, the Umbrella acts as a group incentive. Not only will this act as an incentive if the HCA of an individual is depleted, it will introduce an amount of peer awareness onto the group.

Information

The cornerstone of Interactive Care is the Health Team™. This plan uses state-of-the-art computer and software systems to provide real time integrated information on a cost effective basis. However, implementation of the program is by people working with people. Specifically, each Health Team™. is assigned to serve a designated population of patients, ranging from about 500 for an elderly population to 3000 for a younger, healthier population. The Health Teams™. are lead by registered nurses who are assisted by a clinical medical assistant (CMA) and a customer service representative (CSR).

1. The RN is responsible for most of the clinical aspects of the program.

2. The CSR processes claims and handles claim status questions of the beneficiaries.

3. The CMA fills a swing role of assisting in both the clinical and claims areas while also providing on-site training classes and educational programs.

All members of the Health Team™ have access to the informational systems (although certain clinical features are reserved to the RN and CMA) and can handle a variety of questions and problems brought to them by plan beneficiaries. This approach minimizes transferring callers to various departments for answers. Additionally, large employment facilities with more than 1000 members can have one or more Health Teams™ located on site for immediate access.

A key role of the Health Team™ is to provide consumer information to patients and their families. This information is very important for them to become more involved in their health care and for them to make better, informed decisions. An additional array of information is provided ranging from available providers, rates for specific procedures, information about alternative therapies and diagnostic tests, to the cost of specific drugs. A database is built that provides outcomes data that assesses the performance of physicians and hospitals in a given area.

Interactive Health Services

The Health Teams™ are also instrumental in providing interactive health management to patients. This includes the typical managed care functions of pre-certification and utilization review of significant cases. In addition, Interactive Care involves more comprehensive patient involvement by providing the information and assistance needed in taking control of their health care. Who better to assure that he or she is receiving the care that is proper for them, than each individual? Physicians are right to complain when an insurance company infringes on their decision-making process. However, they will have no cause when it is an informed patient who questions their recommendations.

The Health Teams™ are focused on serving the needs of their specific population. Their function is not to limit or direct the care of the provider, but rather empowers patients to do this themselves. Other services included in Interactive Health care includes:

1. Telephone triage of medical complaints by nurses

2. Identification and stratification of people at risk of significant health problems through a health risk assessment survey and sophisticated data analysis of the medical claims

3. Reminders and notices of important prevention activities, e.g., mammogram every two years for women over the age of 40

4. Large case and disease management.

Together, economic incentives and comprehensive health services, with the proper information and assistance, will turn today's patient into a discerning consumer who will ask questions, demand answers, and take a interactive part in the health care treatment that they receive. The continuum of services provided by the Health Teams™ puts continuity back into health care.

As discussed above, the present invention provides methods for benefits administration and health management.

In one aspect, the present invention provides a method for benefits administration comprising the following steps. A benefit plan for a benefit year comprising a Health Care Account and an Umbrella Account is provided. Premiums are collected for deposit into the benefit plan to form a funded Health Care Account and a funded Umbrella Account. Claims made by a benefit plan beneficiary are processed to form processed claims. Funds are then disbursed from the funded Health Care Account or the funded Umbrella Account to health care service providers to pay the processed claims. Any funds remaining in the funded Health Care Account or funded Umbrella Account is then distributed at the end of the benefit year.

As can be seen, the method provides for a benefit plan comprising a Health Care Account and an Umbrella Account. The Health Care Account, funded through part of the employer's premium, is used for the initial payment of medical expenditures after any required patient deductible is met. The Umbrella Account covers catastrophic or chronic coverage after the deductible and Health Care Account are depleted.

As can be appreciated by one of ordinary skill in the art, the Health Care Account is geared towards use by an individual or family, and as such is funded directly by premium payments, as discussed elsewhere herein. The Umbrella Account, because it is designed as a major medical account, is typically funded as a group account. That is, premiums are pooled from a group of benefit plan enrollees, to fund the Umbrella Account for the benefit of the benefit plan beneficiaries.

The benefit plan is funded through the collection of premium funds from, for example, benefit plan enrollees. A benefit plan enrollee can be an employee of a company offering a benefit plan according to a method of the invention. Alternatively, the premium funds can be collected from a third party source on behalf of a benefit plan enrollee. For example, a company can provide, as a fringe benefit, a benefit plan according to a method of the invention in which the company pays the premiums on behalf of its employees. In another alternative, an employer and employee can split the premium amount, with, for example, 80 percent of the premium being paid by the employer while the employee pays the remaining 20 percent. The amount of any such premium split between employer and employee is a function of the particular benefit plan.

Where a benefit plan according to a method of the invention is designed to be a public health benefit program, premium dollars can be provided through taxpayer funding. Alternatively, a benefit plan enrollee in a public health benefit plan can be required to pay, for example, 20 percent of the benefit plan premium, while public funds are used to pay the remaining 80 percent. As noted above, the amount of the split between public and private dollars is a function of the particular benefit plan.

The premium funds are used to fund the Health Care Account and the Umbrella Account, forming a funded Health Care Account and a funded Umbrella Account. The funded Health Care Account, and funded Umbrella Account, are for the benefit of the benefit plan beneficiaries. Typically, such beneficiaries would include the benefit plan enrollee (e.g., an employee of a company), and that person's spouse (if any) and minor children (if any). The benefit plan can, however, be established for the benefit of other beneficiaries.

In one embodiment, the funded Health Care Account would be used to pay for routine medical services, such as annual physical examinations by a physician, walk-in visits for routine illnesses such as colds or flu, or pre-natal visits for a pregnant patient. The Umbrella Account would provide major medical coverage, such as when the Health Care Account was depleted. Typically, such major medical accounts cover debilitating illnesses such as cancer, or chronic illnesses that require extensive hospitalization.

Typically, a beneficiary in generally good health would not need to access funds in a major medical account such as the Umbrella Account. However, to provide a maximum amount of benefits, a method of the invention includes both a Health Care Account and an Umbrella Account.

It is to be understood that, in most such benefit plans, an enrollee or beneficiary would pay a deductible amount in addition to one or more premium payments to fund the Health Care Account and Umbrella Account, although a deductible feature is not required. Thus, for example, a benefit plan of the invention can require the cumulative payment of $500, directly from the beneficiary to health care providers, before any funds are disbursed from the Health Care Account. Alternatively, or in addition to this deductible, a benefit plan of the invention can require a co-payment amount of $10 for every visit to a health care provider, regardless of any amount disbursed from the Health Care Account.

The deductible amounts can be applied on a per-beneficiary basis, or can be applied on a per-family basis. For example, a benefit plan of the invention can require that each beneficiary of any one particular benefit plan enrollee pay $500 directly to health care providers before funds are disbursed from the Health Care Account. Alternatively, a benefit plan of the invention can require that the total amount of funds directly paid to health care providers from all beneficiaries of a particular benefit plan enrollee amounts to $500 before funds are disbursed from the Health Care Account.

The method also provides for processing of claims made against the funded Health Care Account or funded Umbrella Account. The nature of the claims would be defined by the benefit plan itself, in that the scope of coverage can be limited. For example, a benefit plan of the invention can exclude claims relating to elective cosmetic surgery. Such a claim by a benefit plan beneficiary would not be processed against a funded Health Care Account or funded Umbrella Account, and could not be credited as a deductible amount. Local, state and/or federal laws can regulate such exclusions of coverage.

A benefit plan of the invention can also limit the time in which claims must be made against the funded Health Care Account or funded Umbrella Account. Typically, claims must be made in the calendar year in which the expense was incurred. An extended claim period can also be included in a benefit plan, such that all claims for a given calendar year must be made no later than three months after the start of the subsequent calendar year.

A method of the invention also contemplates disbursement of funds to medical providers and employees. Where a benefit plan has a deductible feature, disbursement of funds is not made until the deductible amount is met. Funds from the funded Health Care Account or funded Umbrella Account can be paid directly to a health care service provider, such as a hospital, physician, or pharmacy. Alternatively, funds can be paid to a benefit plan beneficiary for reimbursement of funds paid by the beneficiary to a health care service provider.

In one embodiment of the invention, as employees and their dependants incur “health care” expenses, payments will be made through a succession of deductibles; a personal Health Care Account, funded through part of the employer's premium, for the bulk of normal expenditures; and an Umbrella Account for catastrophic or chronic coverage.

Employees and their dependants are aggressively encouraged to be “smart health care customers” by providing them an opportunity to reap the benefits of utilizing the resources offered to them in the selection of their medical care. At the end of the benefit year, any funds left in the Health Care Accounts are paid directly to the employee. Additionally, if an employee follows the protocols of the plan which are focused on health management, he or she will be rewarded for their participation through a portion of the unspent funds in the Umbrella Account. Thus, every dollar in a funded Health Care Account not spent by a benefit plan beneficiary can be returned to the benefit plan enrollee at the end of the benefit plan year.

Alternatively, funds remaining in the funded Health Care Account or funded Umbrella Account can be rolled over into the next benefit plan year's Health Care Account and Umbrella Account, or individual or family deductible requirement to further decrease the premium amount required to fund those accounts in the following benefit plan year.

In another alternative, funds remaining in the funded Health Care Account or funded Umbrella Account can be rolled over into an Extended Care Account, discussed more fully elsewhere herein.

Thus, a method of the invention provides economic incentives to benefit plan beneficiaries to spend their health care dollars in a more judicious manner.

In yet another aspect, a benefit plan of the present invention provides comprises a Health Care Accounts (HCA), an Umbrella Account, and an Extended Care Accounts. As in the method described above, premiums are collected and divided among these accounts to form funded Health Care Accounts, funded Umbrella Accounts, and funded Extended Care Accounts.

Health Care Accounts

The primary payment for medical care services is from the Health Care Accounts (HCA). In one embodiment, at the beginning of each benefit period a certain amount of money will rest in the HCA of each individual and family. For example, a funded HCA can contain $500 for each individual and $1500 for a family of four per year. As discussed elsewhere herein, a HCA is funded through collection of premiums.

The HCA is similar in function to a debit card or medical expenditure account. The patient presents insurance information to the health care provider, receives the service, and presents his or her HCA card for payment. After the patient's deductible has been met, then the HCA is used for payment of the service rendered. In preferred embodiments, there are no deductibles or co-payments required of beneficiaries while the HCA is utilized. The HCA will belong to the individual or family, to be used only for their defined personal medical bills.

As a financial incentive for the patient to take control and responsibility for their health care, there are monetary benefits if funds exist in the HCA at the end of the benefit period. In one exemplary illustration, remaining funds are distributed in the following manner:

1. one-third will be paid to the individual/family in the form of a health bonus;

2. one-third will be placed as an additional employer contribution into the employee's retirement plan;

3. one-third will be placed into an Extended Care Account (ECA), to be used exclusively by the individual or family as the first line of payment for any long-term care (e.g., nursing home, home health, or hospice care). The ECA can be an interest bearing account, which accumulates funds over years of employment. By staying healthy, there is money in the ECA to deflect burdensome health care costs after retirement.

This distribution scheme is exemplary only. Under a method of the invention, the funds remaining in a funded HCA can be distributed to one of the three options listed above, or alternatively can be rolled-over to fund the next benefit year's benefit plan. Other distribution schemes can be made available that would provide tax-savings benefits, such as other deferred compensation plans that can be funded by these unused medical dollars.

Umbrella Accounts

In a preferred embodiment, the largest percentage of the premium dollar is placed into the Umbrella Account, which is the major medical component of a benefit plan of the invention. Once an individual's Health Care Account is depleted, any further medical costs are paid for out of the Umbrella Account.

In preferred embodiments, the Umbrella Account has other functions. This account can also find the Health Management aspect of the present method, including the Disease State Management and prevention programs. In addition to the Health Care Account, it is another financial incentive for the patient to become a more discerning consumer of medical care. Money remaining in the Umbrella Account at the end of the benefit year can optionally be dispersed amongst the employees, employers, and to pay for additional prevention services. Or, these funds can be distributed in schemes similar or identical to those discussed elsewhere herein in connection with distribution of funds from an HCA at the end of a benefit plan year.

There is also an optional “whistle-blower” type function present in the methods of the present invention. For example, when a patient can show that he or she has been erroneously billed or overcharged for a medical service, the patient receives fifty percent (50%) of the overcharged money. The remaining fifty percent (50%) is returned into the Umbrella Account. The Health Teams, discussed elsewhere herein, can assist the patient in this regard.

Extended Care Accounts

It is commonly known that America has a rapidly aging population. While at present there are 45 million people over the age of sixty, it is predicted that by the year 2010, over 70 million people will be over sixty. As a result, there will be a significant increase in the need for extended care for this older population.

The present invention addresses these needs in various ways. In one aspect, the present invention provides for the development of effective prevention programs. In another aspect, the present invention provides for the formation of Extended Care Accounts through a method of the invention.

These Extended Care Accounts are contributed to by individuals and families using a portion of the money that remains in the Health Care Accounts and the share of funds remaining in the Umbrella Account. These optionally interest bearing accounts are used to lessen the burden placed on people who need home health care, extended care, and hospice care, as they age.

In one aspect, there is an added financial incentive intended to increase the compliance of recommended disease state management and prevention services. For example, as discussed elsewhere herein, patients who ignore Health Team recommendations for these services forfeit the ability to recoup either the Health Care Account or Umbrella Account disbursements they otherwise would receive. These funds instead roll back into the Umbrella Account for the benefit of the group of benefit plan beneficiaries.

For the group (whether fully insured, fully self-insured, or self-insured with stop loss insurance), the expected total amount is determined by the stop loss insurer or employer. That amount includes the administrative costs, as well as the expected medical claims. The HCA is carved out of that amount. The aggregate attachment point is then determined, and is typically in the range of 115%-120% of the expected total amount.

In one aspect, then, if the group's annual cost is greater than the aggregate attachment point, no Umbrella Account or HCA amounts are returned. If the total expected amount is spent, but not up to the aggregate attachment point, then the leftover funds in the HCAs only are returned. If the total expected amount is not exceeded then the leftover funds in both the HCA and the Umbrella is given back to the employees.

The methods of the present invention are particularly well suited for the following entities:

1. Self-insured companies looking for alternatives to providing their employees with quality health care benefits.

2. Multiple Employer Welfare Arrangements (MEWAs), which are employer groups who together create a common insurance fund in which to underwrite the individual employer-member's employee health benefits and obtain better insurance rates.

3. Trade groups or associations seeking to provide employer-members with the benefits associated with economics of scale by pooling of risk over a greater number.

4. Municipalities, which have the incentive to purchase the most cost-effective medical plan for employees.

5. A Medicare pilot project.

The present invention further provides a method of health management to provide long term benefits to employees and their employers. Such benefits arise through stabilization of premium costs over successive years and through better treatment of employee's health concerns which flow back to the employer in the form of productivity. It is well known that 20% of a patient population accounts for 80% of the health care costs. In one embodiment, nurses and other health care professionals are employed to serve on Health Teams that will focus on promoting optimal utilization of health services by this 20% of the population.

The Health Teams will use a collection of activities designed to enhance the purchasing effectiveness of the employees and their dependants, promote optimal health practices through education and preventive medicine, and manage the cost and outcome of chronic and/or critical illnesses. A critical element of the Health Teams' success will be the proactive approach to interacting with patients, and the active use of the latest disease management protocols to increase preventive efforts. This will require the use of an effective information system that will translate medical research results and accepted disease management protocols to the specific needs of individual beneficiaries.

The methods of the present invention integrate several tools in the Health Management aspect of its services that are designed to:

1. provide patients with easy access to comprehensive medical information through written, electronic and personal mediums;

2. encourage patients to seek information and use it; and

3. encourage patients with chronic conditions or having certain risk factors to a particular disease/condition to acquire information to better manage their health.

In one aspect, the Health Management method comprises Health Teams comprised of medical professionals. A Health Team is optionally lead by a nurse practitioner. A Health Team renders personal service to groups of individual beneficiaries. A group size can be as large as approximately 2,500 individual beneficiaries. Health Teams are responsible for a variety of services for their specific group, including:

1. Providing patients with access to medical information on request; Collection of the Health Risk Assessment Data and Medical History for each beneficiary;

2. Determination, supported by a triage system, of those individuals at health risk;

3. Recommendation of appropriate prevention and disease state management protocols for individuals at risk;

4. Telephonic, e-mail, or fax assistance in the patient decision making process;

5. Utilization determination for their group of beneficiaries, on the basis of interacting with the patient, not the provider;

6. Case-management to expedite in-hospital treatment, with the patient and their family;

7. Review of all costly treatment billing with the patient to insure no billing errors, and assist their patients in billing disputes;

8. Coordination and review of out-patient medications;

9. Interaction and exchange of information with the patient's physician.

10. Other medical support staff can link directly with patients and providers to help coordinate and optimize use of medical care services.

Preferably, Health Teams utilize constantly updated health care educational, therapeutic, and preventive protocols to support their efforts. Health Teams focus their proactive efforts primarily on managing the care of high-utilizing patients (the high cost 20% group) while the financial incentive of the Health Care Accounts serves to encourage the other 80% of the population to cost effectively manage the use of health care services. The increased use of the Health Team's services by employees results in longer-term savings to employers. Furthermore it creates obstacles for competitors due to ongoing care management programs, outcomes research developed through employee acquired data and by the personal relationships that will evolve between employees and Health Teams.

Health Teams are a resource the patient can access at any time on any issue related to their health insurance, the plan of care recommended by their physician, or if they simply require more information about their medical concerns. In addition, in some embodiments of the invention, patients are contacted directly by the Health Teams to advise them of relevant information regarding their condition and/or health.

As discussed elsewhere herein, a Health Team is assigned a group of employees and services each of them individually. In addition to the previously described services, the Health Team optionally provides a range of other support services including:

1. Basic information about improved health including the diet, exercise, early warning signs of disease, and the benefits of selected tests and medical screening

2. Information about specific diseases and the treatments available for each disease state

3. Data about the effectiveness of medical care providers and the costs of their services

4. Health evaluation and staging of employees and their dependents to identify members “at risk” and secure preventive or therapeutic intervention as appropriate

5. Development, acceptance and adoption of clinical guidelines by medical providers

6. Active case management of chronic and critically ill patients.

All these activities are designed to assist the covered employees to become better health care customers and earn their portion of savings in the benefits program.

In another aspect, the present invention combines the services of the Health Care Teams and a sophisticated information system in a method to enhance quality, service, and productivity for enrollees while decreasing costs. The use of this method enables enhancement of the quality of care in large populations. This focus of “Health Management” represents a shift in the focal point of medical care delivery. Instead of focusing on the management of many individual patient visits, the providers in population management seek to reduce risks and improve the overall health of defined populations by understanding and coordinating the series of health care needs of individual patients including education, prevention, physician visits, hospital visits, and follow-up efforts. The approach encompasses two major aspects: Prevention and Health Programs, and Disease State Management. The role of the Health Teams in Health Management is to address the three general areas critical to providing value through prevention and health programs: 1) the provision of automatic health maintenance reminders, 2) the monitoring of disease specific outcomes, and 3) the use and dissemination of online clinical guidelines.

Automatic Health Maintenance Reminders

In this aspect, the Health Teams access computerized patient records in order to provide automatic reminders and alerts for routine (i.e., those with no known diseases) and disease specific populations. The reminders can cover recommended preventive measures, such as, for example, childhood and adult immunizations, pap smears, and mammograms. The reminders can also be used to identify “at risk” populations and assign these groups to customized plans for disease specific reminders. Examples include assigning special reminders to diabetics and women at high risk for breast cancer to take required actions to help manage their conditions. The system can also be used to readily search the entire patient database to identify groups of enrollees that are overdue for various recommended procedures. These patients are then contacted and brought into or directed to their physician for appropriate care. In addition, certain populations can automatically be excluded from specific reminders. For example the system can exclude women who have had hysterectomy from Pap smear reminders, unless the patient has a history of pelvic cancer.

An additional aspect involves tracking the reminders to patients who are overdue for various preventive procedures. Once the requisite procedure is ordered and completed the program is flagged “satisfied” until the next interval is reached. The system is limited only by the health maintenance guidelines themselves. For example, there is discord in the medical community about the frequency of screening mammography in women 40 to 50 years of age. In the face of this uncertainty, a Health Team can choose specific and unambiguous rules for the reminders in the computerized patient records system.

In a preferred embodiment, a Community Advisor Board, comprised of physicians, public health experts, and attorneys, preferably from the community, decides on acceptable standards to use throughout the organization. Patient compliance is a limiting factor; therefore, the method includes financial measures through the use of the individual health care account.

Monitoring Disease-Specific Outcomes

Through the use of a comprehensive Clinical Information System (discussed elsewhere herein) the Health Teams of the present invention identify patients with certain common diseases, such as diabetes, chronic obstructive pulmonary disease, heart disease, and/or psychological issues, that are amenable to proactive intervention. The system identifies patients meeting the criteria for the various diseases. The Health Teams then call patients who require follow-up and triage them accordingly. There is evidence to show that the use of patient contact increases compliance by up to 80 percent. This effort will result in improved care and outcomes for the targeted populations. By using these computer directed outreach efforts to contact disease specific populations and by continuing to improve the way the Health Teams interact with and support patients, the long term health of the patients is expected to be improved and concomitantly resulting in a lower cost.

Disease State Management Initiative

The third critical quality tool available to enrollees through the Health Teams is a disease-specific management program. A list of initial pilot programs and their objectives are found elsewhere herein. They include, for example, management guidelines for the outpatient treatment of congestive heart failure, chronic care programs for patients with two or more chronic conditions, as well as work-site education programs for diabetes and chronic lung disease.

As can be seen, the Health Team links directly to patients using a variety of vehicles: phone, clinic programs, employer-site information sessions, and educational materials. Providing direct insight into the role patients themselves can play allows patients to use the information to make the appropriate behavioral and preventive changes specific to their needs. Similarly, these Health Teams can link with providers as well.

The Health Teams' success is predicated on changing the practice of both patients and physicians engaging only in the traditional episodic focus of care delivery, which is often a barrier to achieving population management. The present invention uses the information system to implement the Health Management strategy designed to improve screening of general and high-risk populations for critical health maintenance interventions. This provides higher quality of care, improve medical outcomes, and result in long-term cost reductions across a healthier population. In the present invention, key clinical processes are re-engineered to leverage powerful information tools. By balancing the demand of episodic visit care and population health management goals, the present invention restructures medical delivery systems from physician centered workflows toward team centered workflows.

Information Systems

In another aspect, the present invention is directed to a clinical information system comprising a third party administrator component, a health management component, and a health risk assessment/medical history component.

Preferably, the system requirements include the following features:

1. All components are be interchangeable.

2. All components are user friendly.

3. All components allow for easy input, manipulation, and retrieval of data.

4. Allow for retrieval and transfer of certain information electronically, with appropriate security measures.

TPA Component.

The Third Party Administrator (“TPA”) component optionally includes a basic claims administration software system, an ad hoc reporter writer, code review, case management and accounting.

Health Management Component.

This component is used by the Health Teams. The Health Teams are able to access and manipulate critical patient data on a real-time basis.

Health Risk Assessment/Medical History.

This component allows the patient data to be entered into both the TPA and Health Management systems, “handsfree.”

In some preferred embodiments, the system includes pharmacy benefits management. Also, the TPA system also optionally works with the self-funded entity for the disbursement of funds.

### EXAMPLE 1

Self-Funded Purchasing Alliance

Unless Congress were to pass sweeping legislation doing away with the private aspect of employer sponsored health care system, a way must be found to increase access for all who work to obtain affordable medical coverage. Even if Congress were to pass mandated employer sponsored health care, smaller employers would need to find a way to purchase quality health care at affordable prices. Self-Funded purchasing alliances would solve this problem.

There is a mechanism now available to carry out this function. These are Multiple Employer Welfare Arrangements. (MEWAs). Currently MEWAs are regulated by the states, somewhat haphazardly. Federal legislation could make these more accessible and more affordable to those who work.

However, without new legislation, the present invention provides a method to give small and medium employers the same benefits that larger self-funded employers enjoy:

1. Self-funded plans are regulated by ERISA, which decreases state regulations, lowering administrative costs.

2. Administrative protocols are standardized, lowering administrative costs.

3. State insurance premium taxes, where in place, do not apply.

4. When the group reaches a large enough pool, community-based rating is used, ending expensive underwriting costs.

5. Being a community-based program, advertising and agent percentage costs are diminished.

6. Insurance company profit and risk charges are reduced.

7. Reserve Trust pool interest is tax free, and the trust can be used to mitigate or lower yearly increases in medical treatment costs.

8. The ability for benefit package to be tailored to meet the self-insured's specific needs.

9. For smaller self-insured groups, stop-loss insurance may be purchased for plan security.

The method of the present invention can use the reserve function of any self-funded entity, whether a MEWA or a larger self-insured employer, to lower costs in the long run. At the start of the benefit year, the amount necessary to fund the plan will be determined. After the amounts for the Health Care Accounts and the administrative costs are subtracted, the remainder will be placed into the Umbrella/reserve.

This money will be used to fund the medical claims after the Health Care Accounts are depleted. At the end of the benefit year, money left over is divided; for example, 40% to the employer, 40% to be divided equally among the employees, 10% to fund additional prevention programs for the covered beneficiaries, and 10% for administrative costs.

The control of each regional group is through an advisory board consisting of proportionate representation of employers and employees, depending on the payment of premiums.

### EXAMPLE 2

Health Team Information System Components

Asthma:

Members with Asthma will learn to manage their condition with the help of a respiratory care specialist. Patients will learn to focus on self-monitoring techniques, identifying triggers and maintaining normal physical and social activities

Chronic Diseases:

Health Teams will target enrollees, who, on average, have two to three chronic health conditions. Health Team interventions will serve to reinforce their physicians' care management objectives and coordinate treatment plans prescribed. Enhancement of enrollee's quality of life and their experience with health care providers will be obtained.

Congestive Heart Failure:

Health Teams will work with enrollees to ensure compliance with treatment plans, to evaluate reinforce physician objectives, and to emphasize educational issues. Obtainable goals include significant reductions in hospital admissions (up to 60%) and related costs; improvement in functional status and quality of life; improving on existing laggard medical practices.

Prenatal Care Coordination:

Health Teams will oversee a comprehensive prenatal program that includes patient education, prenatal and postpartum risk assessments, and case management services.

End Stage Renal Disease:

Medicare's largest group of high-cost users are patients with End Stage Renal Disease. Health Teams will bring together teams of expert nephrologists, nurses and other health care professionals to better manage dialysis patients and provide coordinated high quality care

Diabetes:

Health Teams will coordinate work-site education projects and utilize a state of the art Diabetes Information Service to facilitate the provision of quality diabetes care. Long term objectives are significant reductions in the development of Diabetes related complications such as vision loss, development of End Stage Renal Disease and Peripheral Vascular Disease.

24 Hour Advice Line:

Health Teams will manage a 24-hour medical information service which allows enrollees to speak with trained professionals about symptoms or health questions any time of day.

1. Expert Systems

Group enrollees will be identified through a series of rules developed by its Clinical Advisory Board. The rules will include both utilization markers and cost parameters (vis-vis both patients and providers). This process will triage enrollees into categories—Low, Moderate, and High Risk. The appropriate interventions from the care management guidelines will be specific to the risk level.

2. Population Database

A comprehensive query of enrollees conducted by Health Teams. Information gathered will include: clinical data, diagnostic results, symptomatic data, pharmaceutical history, humanistic data, psychosocial data, financial data, environmental data, patient satisfaction data, and QOL data. The system will be built to interface and transmit real time data through interaction with other components of the Information systems infrastructure: PBM, TPA, Network Providers, and the ongoing use of the Expert System. As data arrives in this central enrollee database, the Expert System will review the data through a series of clinical rules, and will determine if an intervention is necessary by the Health Team. This provides an electronic real time means to evaluate information on a consistent basis throughout the population.

3. Care Management Guidelines

These guidelines will instruct the Health Team on what to do when they are alerted by the Expert System by moving the Health Team member through a series of prescribed interventions for a given enrollee. These will be integrated ultimately for multiple disease conditions, thus providing one a single source of information for people with multiple disease states. The tracks utilized will comprehensively span the entire continuum of care from risk assessment through the terminal stages. Outcomes will be attached to each phase of care, with enrollees moving from phase to phase based on the achievement of expected outcomes. The outcomes assessment will include recording real and desired outcomes and using the results to continually improve and modify the guidelines. The Advisory Panel will be comprised of local thought leaders from multiple disciplines to insure all clinical and other appropriate issues are addressed.

4. Research and Outcomes Database

The outcomes tracked will allow for assistance to providers in evaluating the results of their specific management. The data will be made available to providers to assist them in reporting and interpreting their results to various oversight bodies (e.g. NCQA). The outcomes initiative will also capture and collate the cost savings data to share with the enrollees and their providers. The clinical data will also allow the Health Teams to evaluate treatment plans and determine the efficacy of particular clinical regimens.

The described embodiments of the invention are intended to be merely exemplary and numerous variations and modifications will be apparent to those skilled in the art. All such variations and modifications are intended to be within the scope of the present invention.

1. A method of health management comprising providing a Health Team for a defined group of benefit plan beneficiaries, said Health Team being responsible for services to said defined group of benefit plan beneficiaries comprising:
a) providing prevention protocols to said defined group of benefit plan beneficiaries;
b) collection of Health Risk Assessment Data and Medical History for each member of said defined group of benefit plan beneficiaries;
c) paying medical and health services claims for specific members of said defined group of benefit plan beneficiaries;
d) performing utilization review and pre-certification services for specific members of said defined group of benefit plan beneficiaries;
e) performing telephone triage for specific members of said defined group of benefit plan beneficiaries;
f) providing health information, including automatic health and early detection reminders, to specific members of said defined group of benefit plan beneficiaries;
g) monitoring disease-specific outcomes to identify specific at-risk members of said defined group of benefit plan beneficiaries with disease states amenable to pro-active medical and health interventions, and to secure appropriate preventive or therapeutic intervention for the specific at-risk members; and
h) implementing disease and case management services and programs for the specific at-risk members of said defined group of benefit plan beneficiaries.

2. A clinical information system comprising a third party administrator component, a health management component, and a health risk assessment/medical history component.

3. The clinical information system of claim 2 wherein said third party administrator component comprises a basic claims administration software system, an ad hoc reporter writer, a code review system, a case management system, accounting software and data management system.

4. The clinical information system of claim 2 wherein said third party administrator component further comprises a funds disbursement system.

5. The clinical information system of claim 2 further comprising a pharmacy benefits management component.
